(19) United States
(12) Patent Application Publication
(10) Pub. No.: US 2009/0301926 A1
(43) Pub. Date: Dec. 10, 2009

(54) SLIP SHEET

(76) Inventor: Sean T. Ogburn, Hoschton, GA (US)

Correspondence Address: CARLSON, GASKEY & OLDS, P.C., 400 WEST MAPLE ROAD, SUITE 350, BIRMINGHAM, MI, 48009, US

(21) Appl. No.: 12/133,622

(22) Filed: Jun. 5, 2008

(51) Int. Cl. B65D 1/36; B65D 21/02; B65D 21/00; B29C 35/02

(52) U.S. Cl. 206/564; 206/509; 220/23.83; 264/522

(57) ABSTRACT

A slip sheet is thermoformed as a single-piece plastic sheet body to include a lower surface with a first set of features and an upper surface with a second set of features. The slip sheet is to be positioned between adjacent layers of stacked containers such that the first set of features interfaces directly with container tops and the second set of features supports the container bottoms. The slip sheet includes a hinge that allows one portion of the sheet body to be pivoted relative to another portion of the sheet body to provide access to a lower layer of containers.

### BACKGROUND OF THE INVENTION

Sets of containers or bottles for holding juice, water, etc. are often stacked on top of each other on a pallet to facilitate transportation and storage. Typically, one or more sets of containers are placed in a crate, and then several crates are placed on the pallet to form a layer. Crates are then stacked on top of other crates to form additional vertical layers of crates.

In order to increase the stacking capacity, a slip sheet is inserted between some of the layers. The slip sheet operates to more evenly distribute load across the layers to allow for higher stacking. For example, three layers of crates can be stacked on top of each other with a slip sheet then being placed on top of the third layer. More layers of crates can then be stacked on top of the slip sheet. Depending upon the size, shape, etc. of the crates and containers, another slip sheet could then be placed on top of the additional layers with more layers of crates then being stacked on top of the second slip sheet.

The crates and slip sheets are formed by using injection molded plastic, which can be expensive. Another disadvantage with current slip sheets is that it is difficult to access containers that are in layers underneath the slip sheet. To access these containers, all of the containers that are on top of the slip sheet must be removed so that the slip sheet can then be removed to provide access to the lower layers of containers.

### SUMMARY OF THE INVENTION

The present invention provides a slip sheet for interfacing between immediately adjacent stacked layers of containers.

The example slip sheet comprises a sheet body with a hinge portion that allows one portion of the sheet body to be pivoted relative to another portion of the sheet body to provide access to lower layers of containers.

In one example, a wall is formed about a perimeter of the slip sheet body. The wall extends upwardly beyond the upper surface to form a shallow cavity that receives the bottoms of the containers. In one example, the hinge is formed within the wall.

In one example, the sheet body comprises a thermoformed, single-piece plastic slip sheet body.

In one example, the sheet body includes a first set of features formed in a lower surface and a second set of features formed in an upper surface. The first set of features directly interfaces with container tops and the second set of features supports the container bottoms.

In one example, the first set of features comprises recesses formed within the lower surface that provide corresponding protrusions that protrude upwardly from the upper surface. The container tops are directly received within the recesses. The second set of features comprises recesses formed within the upper surface that directly receive the container bottoms.

In one example, the first set of features comprises recesses formed within the lower surface that directly interface with container tops and the second set of features comprise substantially flat areas formed in the upper surface that support crates that receive the container bottoms.

These and other features of the present invention can be best understood from the following specification and drawings, the following of which is a brief description.

### BRIEF DESCRIPTION OF THE DRAWINGS

FIG. 1 shows a perspective view of a loaded pallet with a slip sheet between stacked layers.

FIG. 2 shows a perspective view of one example of a slip sheet in accordance with the present invention.

FIG. 3 is a top view of the slip sheet of FIG. 2.

FIG. 4 is a side view of the slip sheet of FIG. 2.

FIG. 5 is an end view of the slip sheet of FIG. 2.

FIG. 6 shows a perspective view of another example of a slip sheet in accordance with the present invention.

FIG. 7 is a top view of the slip sheet of FIG. 6.

FIG. 8 shows a bottom view of the slip sheet of FIG. 6.

FIG. 9 is a side view of the slip sheet of FIG. 6.

FIG. 10 is an end view of the slip sheet of FIG. 6.

### DETAILED DESCRIPTION OF THE PREFERRED EMBODIMENT

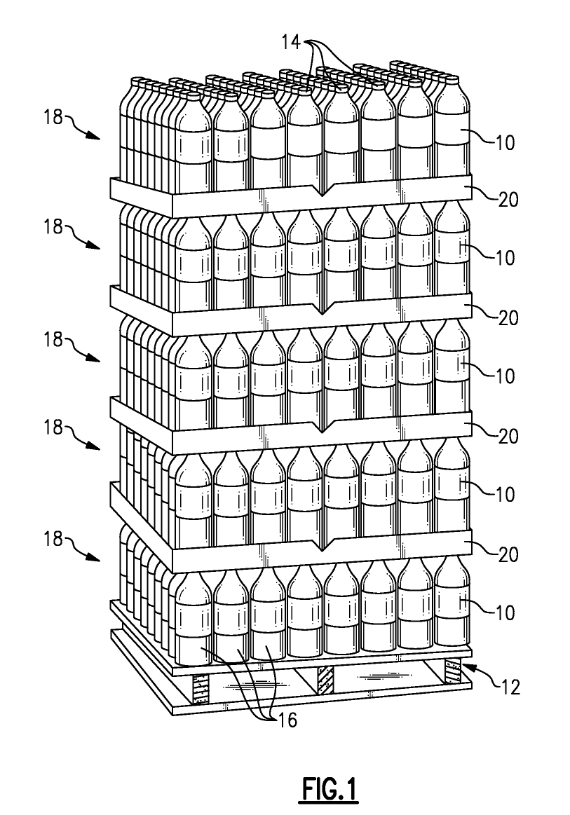

FIG. 1 shows a plurality of stacked containers 10 that are supported for transportation and storage on a pallet 12. Each container 10 is configured to hold a fluid, such as water, juice, soda, etc., and includes a container top 14 and a container bottom 16. The containers 10 are stacked on top of each other to form a plurality of layers 18. Between each layer 18 is a slip sheet 20 that is used to increase stacking capacity on the pallet 12.

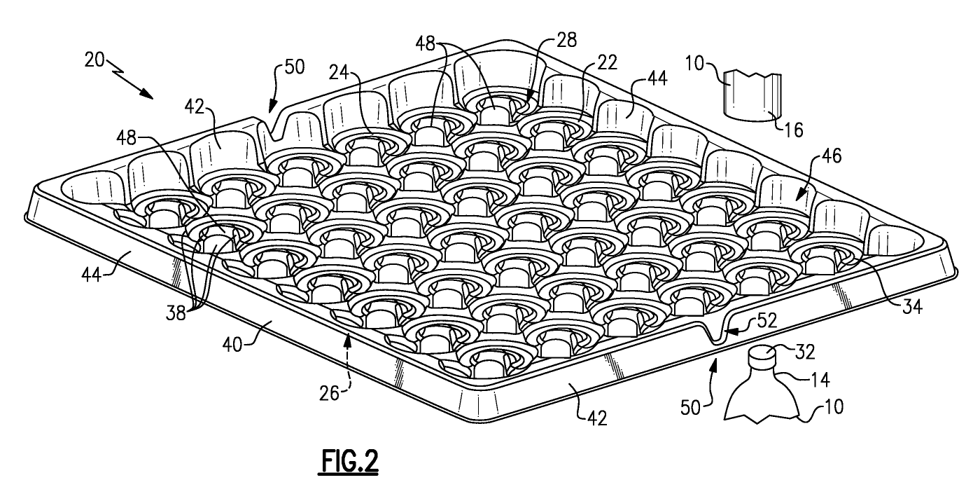

As shown in FIG. 2, each slip sheet 20 comprises a single-piece slip sheet body that has a lower surface 22 and an upper surface 24. A first set of locating features 26 are formed in the lower surface 22 to interface with the container tops 14 and a second set of locating features 28 are formed in the upper surface 24 to interface with the container bottoms 16.

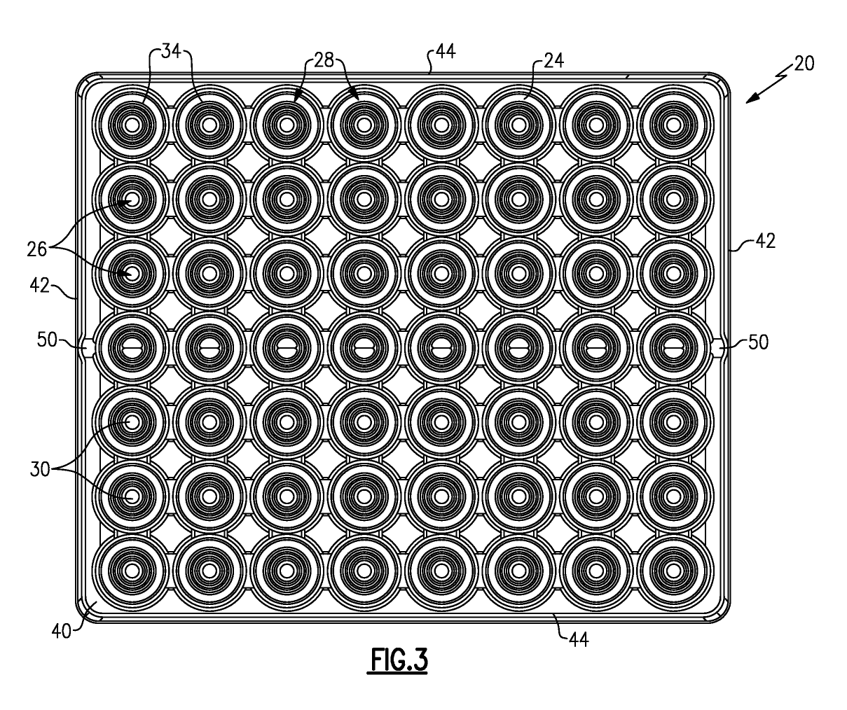

In the example shown in FIG. 2, the first set of locating features 26 comprise dimples or protrusions 30 (FIG. 3) that extend upwardly from the upper surface 24. The protrusions 30 provide corresponding recesses formed in the lower surface 22. Caps 32 (FIG. 2) that are secured to the container tops 14 are received within these recesses. The second set of locating features 28 comprise recesses 34 that are formed in the upper surface 24 to receive the container bottoms 16.

FIG. 3 shows an example configuration where the recesses 34 are formed to have the same shape and size, and a formed in a symmetrical pattern within the slip sheet 20. Also in this example the protrusions 30 and recesses 34 are concentric with each other.

As shown in FIGS. 2, 4, and 5, a wall 40 is formed about a perimeter of the slip sheet 20. The wall 40 extends upwardly beyond the upper surface 24 of the slip sheet 20. The wall 40 includes a first set of opposing walls 42 that are connected to each other with a second set of opposing walls 44. The first 42 and second 44 sets of opposing walls cooperate to provide a shallow cavity 46 that receives the container bottoms 16. The wall 40 provides increased structural rigidity for the slip sheet 20.

The slip sheet 20 includes a plurality of discretely spaced support protrusions 48 that are positioned between adjacent recesses 34. The support protrusions 48 provide support surfaces 38 for side walls of different containers 10. In the example shown in FIG. 2, each support protrusion 48 provides four different support surfaces 38 for four different containers.

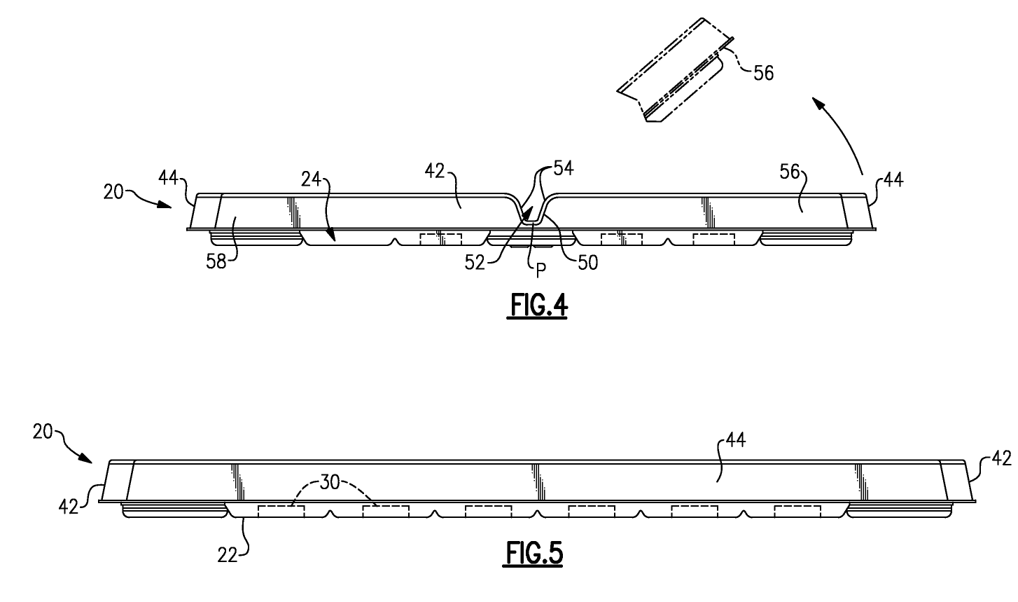

Each slip sheet 20 also includes a hinge portion 50. In the example shown in FIG. 2, the hinge portion 50 comprises a living hinge that is integrally formed within the wall 40. The hinge portion 50 is formed in one of the first 42 and/or second 44 sets of opposing walls. The hinge portion 50 is formed at a removed section 52, i.e. a reduced cross-sectional area portion, of the wall 40 (FIG. 4).

As shown in FIG. 4, the hinge portion 50 is defined by sloped surfaces 54 that transition into bottom surface that defines a hinge point P. The sloped surfaces 54 are obliquely orientated relative to the upper surface 24 of the slip sheet 20. The hinge portion 50 allows a first portion 56 of the slip sheet 20 to be pivoted about the hinge point P relative to a second portion 58 of the slip sheet 20. The second portion 58 is also pivotable relative to the first portion 56. When one of the first 56 or second 58 portions is pivoted, access is provided to a lower layer 18 in the plurality of stacked layers 18.

In the example shown in FIGS. 4-5, the hinge portion 50 is formed in the first set of opposing walls 42, which form a side of the slip sheet that would face an aisle for display purposes. The ends of the slip sheet 20, shown in FIG. 5, do not include a hinge portion; however, these walls could include a hinge portion in place of, or in addition to, the hinge portion 50. Further, the height of the wall 40 can be increased to further increase structurally rigidity for larger containers or can be decreased when smaller containers are used.

In this configuration, crates or boxes are not needed to hold containers within an individual layer. The only interface between layers that is necessary is the slip sheet 20. Thus, the slip sheet 20 serves to locate and hold containers 10 in place within each layer, as well as serving to evenly distribute loading across a layer to increase stacking capacity. Eliminating the need for crates within each layer significantly reduces cost.

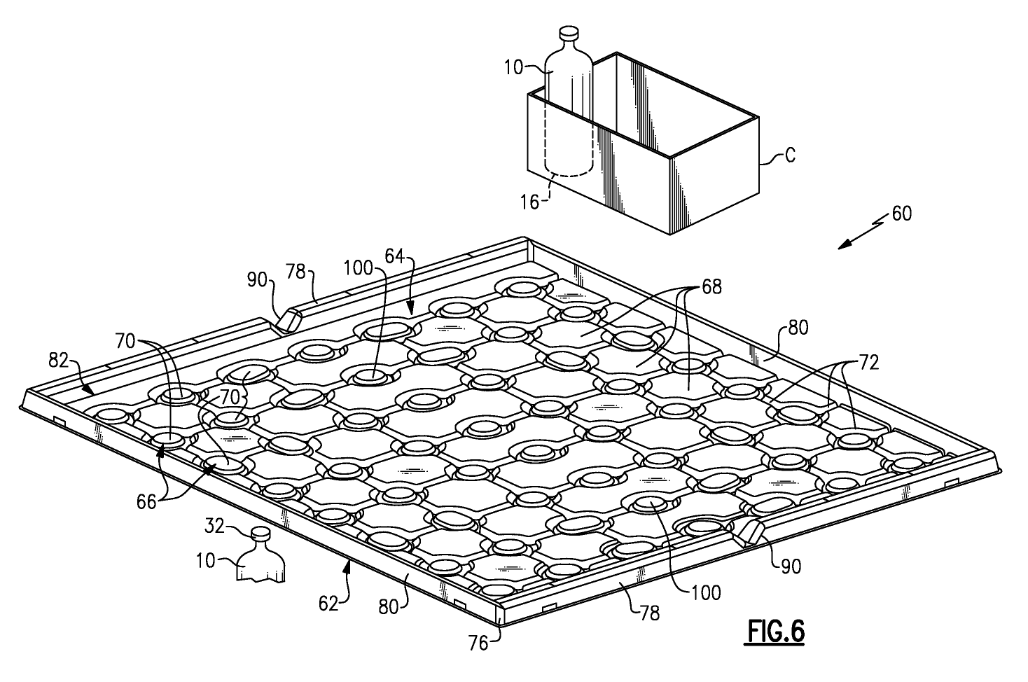

FIGS. 6-10 show another example of a slip sheet 60. In this example, the slip sheet 60 is used in a configuration where the containers are stored in boxes or crates. Each slip sheet 60 comprises a single-piece slip sheet body that has a lower surface 62 and an upper surface 64. A first set of locating features 66 are formed in the lower surface 62 to interface with the container tops 14. The upper surface 64 provides substantially flat areas 68 that are to interface with a box or crate C that receives the container bottoms 16.

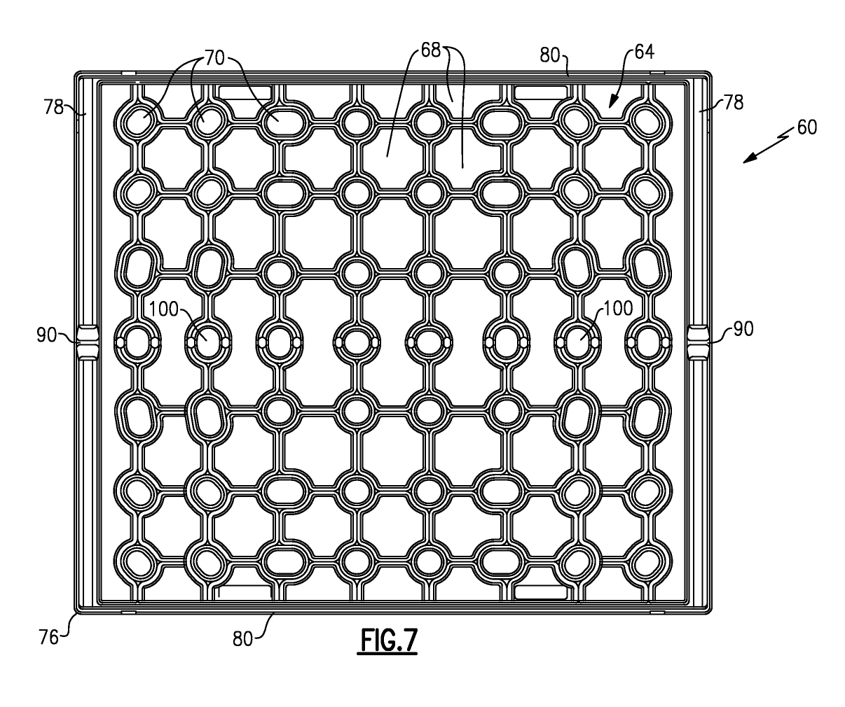

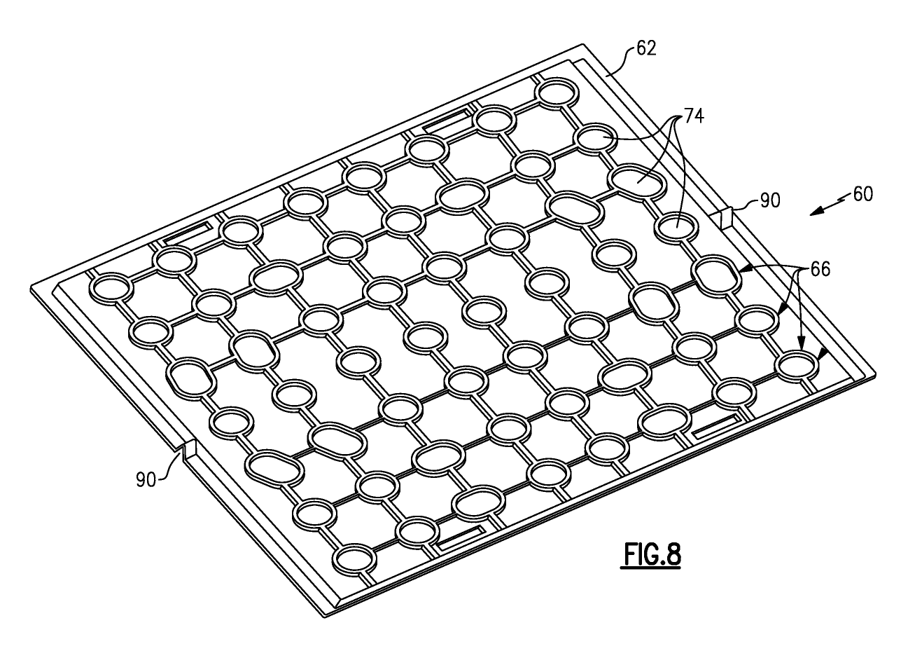

As shown in FIGS. 6-7, the first set of locating features 66 comprise bosses 70 formed at the upper surface 64 which form corresponding cap recesses 74 (FIG. 8) on the lower surface 62. The cap recesses 74 receive the caps 32 that are secured to container tops 14. The cap recesses 74 locate the containers relative to the slip sheet 60.

The flat areas 68 and bosses are separated from each other by an array of recesses or grooves 72 that define the shape of the bosses 70 and the shape of the flat areas 68. The bosses 70 and the flat areas 68 have surfaces that are generally co-planer with the grooves 70 extending downwardly away from the bosses 70 and flat areas 68. Formation of the grooves also reduces the weight of the slip sheet.

FIG. 7 shows an example configuration where the slip sheet 60 is configured to accommodate containers that have different cap sizes and shapes within a single layer of containers. As shown in FIGS. 7-8, some of the cap recesses have a circular shape, while other recesses have an oval shape. Further, the recesses are arranged in varying patterns such that circular and non-circular recesses can be alternated individually or in groups. Also, as shown in FIG. 7, the slip sheet 60 includes small vacuum break holes 100 to allow nested sheets to be easily separated from each other. Slip sheet 20 could be similarly configured to include such holes.

As shown in FIGS. 6, 9, and 10, a wall 76 is formed about a perimeter of the slip sheet 60. The wall 76 extends upwardly beyond the upper surface 64 of the slip sheet 60. The wall 76 includes a first set of opposing walls 78 that are connected to each other with a second set of opposing walls 80. The first 78 and second 80 sets of opposing walls cooperate to provide a shallow cavity 82 that receives the container bottoms 16. The wall 76 provides increased structural rigidity for the slip sheet 60. The height of the wall 76 can be increased to further increase structurally rigidity for larger containers or can be decreased when smaller containers are used.

Each slip sheet 60 also includes a hinge portion 90. In the example shown in FIG. 62, the hinge portion 90 comprises a living hinge that is formed similarly to that shown in FIGS. 2-5.

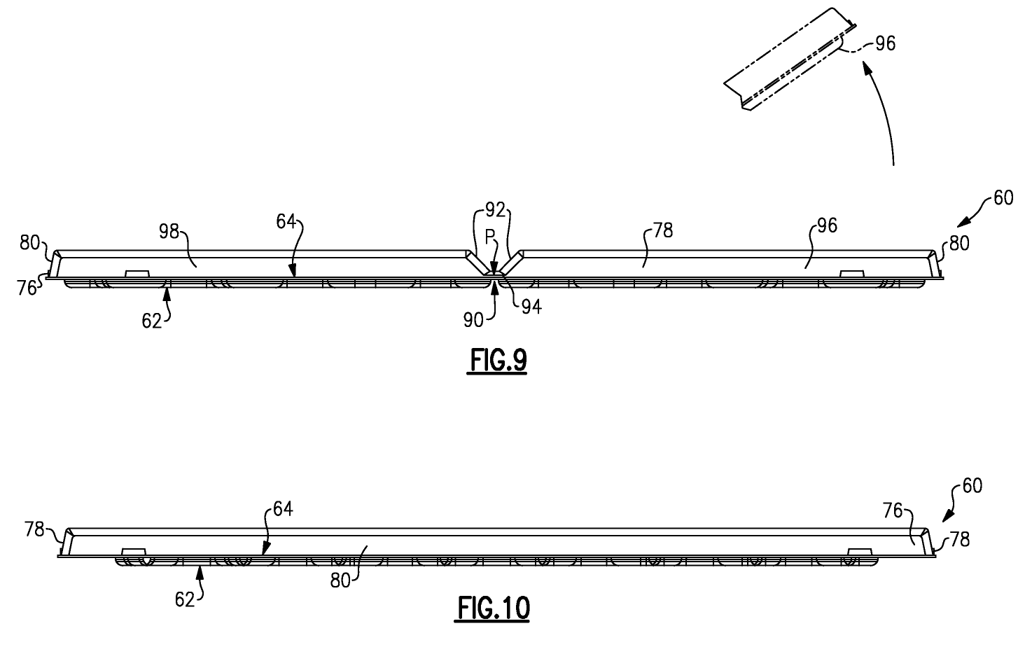

As shown in FIG. 9, the hinge portion 90 is defined by sloped surfaces 92 that transition into bottom surface 94 that defines a hinge point P. The sloped surfaces 92 are obliquely orientated relative to the upper surface 64 of the slip sheet 60. The hinge portion 90 allows a first portion 96 of the slip sheet 60 to be pivoted about the hinge point relative to a second portion 98 of the slip sheet 60. The second portion 98 is also pivotable relative to the first portion 96. When one of the first 96 or second 98 portions is pivoted, access is provided to a lower layer 18 in the plurality of stacked layers 18.

In the example shown in FIG. 9, the hinge portion 90 is formed in the first set of opposing walls 78, which form a side of the slip sheet 60 that would face an aisle for display purposes. The ends of the slip sheet 60, shown in FIG. 10, do not include a hinge portion; however, these walls could include a hinge portion in place of, or in addition to, the hinge portion 90.

Each slip sheet 20, 60 is made from a plastic material using a thermoforming process. Thermoforming the slip sheets 20, 60 significantly reduces cost compared to prior injected molded sheets. In a thermoforming process, heated plastic sheets of material are placed over a mold and a vacuum is used to draw the plastic against the mold, which forms the sheet into the desired shape when cooled.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A slip sheet comprising:
a sheet body having an upper surface and a lower surface;
a first set of features formed in the lower surface to interface with container tops; and
a hinge portion that allows one portion of the sheet body to be pivoted relative to another portion of the sheet body.

2. The slip sheet of claim 1 wherein the sheet body includes a second set of features formed in the upper surface to support container bottoms wherein the sheet body with the first and second sets of features is formed as a single-piece thermoformed plastic slip sheet.

3. The slip sheet of claim 2 wherein the first set of features comprise a first set of locating features that directly cooperate with the container tops and the second set of features comprise a second set of locating features that directly cooperate with the container bottoms.

4. The slip sheet of claim 3 wherein the first set of locating features comprise a plurality of protrusions that extend outwardly from the upper surface to form container top recesses in the lower surface, and wherein the second set of locating features comprise a plurality of container bottom recesses formed in the upper surface.

5. The slip sheet of claim 4 wherein each protrusion is concentric with a corresponding container bottom recess.

6. The slip sheet of claim 4 including a plurality of discretely spaced support protrusions located between adjacent container bottom recesses, wherein each support protrusion provides at least one support surface to support a side wall of a container.

7. The slip sheet of claim 6 wherein each support protrusion provides a plurality of support surfaces to support side walls for multiple containers.

8. The slip sheet of claim 7 wherein each support protrusion includes four support surfaces to support side walls for four different containers.

9. The slip sheet of claim 2 wherein the first set of features comprise a set of locating features that directly cooperate with the container tops and the second set of features comprise a set of generally flat surfaces that provide support for a crate that receives the container bottoms.

10. The slip sheet of claim 1 wherein the sheet body includes a wall portion formed about a perimeter of the sheet body, the wall portion extending upwardly beyond the upper surface of the sheet body.

11. The slip sheet of claim 10 wherein the hinge portion is formed in the wall portion.

12. The slip sheet of claim 11 wherein the hinge portion comprises a removed section of the wall portion.

13. The slip sheet of claim 11 wherein the wall portion includes a first set of opposing walls that are connected to each other by a second set of opposing walls, and wherein the hinge portion comprises a notch formed in one of the first and second sets of opposing walls.

14. The slip sheet of claim 13 wherein the notch is formed in each opposing wall of the one of the first and second sets of opposing walls, the notches being defined by a pair of sloped surfaces that are obliquely orientated relative to the upper surface of the sheet body.

15. The slip sheet of claim 1 including a plurality of vacuum break holes formed within the sheet body.

16. A method of forming a slip sheet comprising:
thermoforming a single-piece slip sheet body to include a first set of features formed in a lower surface to interface with container tops, a second set of features formed in an upper surface to support container bottoms, and a hinge portion that allows one portion of the slip sheet body to be pivoted relative to another portion of the slip sheet body.

17. The method of claim 16 including forming a wall about a perimeter of the slip sheet body that extends upwardly beyond the upper surface of the slip sheet body, and forming the hinge portion in the wall.

18. The method of claim 16 including forming the first set of features as a first set of locating features that directly cooperate with the container tops and forming the second set of features as a second set of locating features that directly cooperate with the container bottoms.

19. The method of claim 18 including forming the first set of locating features as a plurality of protrusions that extend upwardly from the upper surface to form container top recesses in the lower surface and forming the second set of locating features as a plurality of container bottom recesses that are concentric with the protrusions.

20. The method of claim 19 including forming a plurality of discretely spaced support protrusions located between adjacent container bottom recesses, wherein each support protrusion provides at least one support surface to support a side wall of a container.

21. The method of claim 20 wherein each support protrusion provides a plurality of support surfaces to support side walls for multiple containers.

22. The method of claim 16 including forming the first set of features as a set of locating features that directly cooperate with the container tops and forming the second set of features as a set of generally flat surfaces that provide support for a crate that receives the container bottoms.

23. A container unit comprising:
a plurality of vertically stacked layers of containers wherein each container has a container top and a container bottom;
a plurality of slip sheets, each slip sheet having a single-piece plastic sheet body having a lower surface with a first set of features to be associated with the container tops, an upper surface with a second set of features to be associated with the container bottoms, and a hinge portion that allows one portion of the slip sheet to be pivoted upwardly relative to another portion of the slip sheet to provide access to a lower layer of containers.

24. The container unit of claim 23 wherein one slip sheet is positioned between each immediately adjacent layer of containers such that the first set of features directly engage container tops of a lower layer of containers and the second set of features support container bottoms of an upper layer of containers.

25. The container unit of claim 24 wherein the container unit comprises a crateless unit with only one slip sheet separating immediately adjacent stacked layers of containers.

26. The container unit of claim 25 wherein the first set of features comprises a first set of locating features that directly cooperate with the container tops and the second set of features comprises a second set of locating features that directly cooperate with the container bottoms.

27. The container unit of claim 26 wherein the first set of locating features comprise a plurality of protrusions that extend upwardly from the upper surface to form container top recesses in the lower surface, and wherein the second set of locating features comprises a plurality of container bottom recesses that are concentric with the protrusions.

28. The container unit of claim 27 including a plurality of discretely spaced support protrusions located between adjacent container bottom recesses, wherein each support protrusion provides a plurality of support surfaces to support side walls for multiple containers.

29. The container unit of claim 24 wherein the first set of features comprises a set of locating features that directly cooperate with the container tops and wherein the second set of features comprises a set of generally flat surfaces that provide support for a crate that receives the container bottoms.

30. The container unit of claim 23 wherein each slip sheet has a wall formed about a perimeter of the sheet body that extends upwardly beyond the upper surface of the sheet body to form a shallow cavity to receive the container bottoms, and wherein the hinge portion is formed within the wall.
